(19) United States
(12) Patent Application Publication
(10) Pub. No.: US 2026/0170594 A1
(43) Pub. Date: Jun. 18, 2026

(54) Driver Support for ROMless Graphics Processors

(71) Applicant: Advanced Micro Devices, Inc., Santa Clara, CA (US)

(72) Inventors: XiaoFeng Wang, Shanghai (CN); ShuaiJie Gu, Shanghai (CN); WeiXing Nan, Shanghai (CN)

(73) Assignee: Advanced Micro Devices, Inc., Santa Clara, CA (US)

(21) Appl. No.: 18/986,397

(22) Filed: Dec. 18, 2024

(51) Int. Cl. G06T 1/20; G06T 1/60

(52) U.S. Cl. CPC G06T 1/20; G06T 1/60

(57) ABSTRACT

In accordance with the described techniques, a system includes a central processing unit (CPU) having a driver that includes a plurality of firmware images of a plurality of graphics processor architectures. Each of the firmware images include assembly logic of a plurality of CPU architectures. The CPU, by executing the driver, establishes an interface between a graphics processor and the CPU using the assembly logic block of the CPU within the firmware image of the graphics processor. The graphics processor has removed therefrom a non-volatile memory chip dedicated to storing the firmware image. The driver communicates the firmware image of the graphics processor via the interface for execution by the graphics processor.

### BACKGROUND

Typically, graphics processing units (e.g., GPUs) are implemented in a device or system (e.g., a system-on-a-chip) along with a central processing unit, e.g., CPU. GPUs are specialized processors designed to execute graphics processing workloads or applications faster than the CPU. Accordingly, the CPU offloads graphics processing workloads or applications to the GPU for execution to improve performance of the device or system. A “ROMless” GPU does not have a dedicated read-only memory (ROM) chip for storing the GPU's essential firmware. Instead, a ROMless GPU relies on external memory sources to load this firmware. ROMless operation of a GPU reduces the cost of producing the GPU, and reduces hardware footprint for the device or system.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system to implement driver support for ROMless graphics processors.

FIG. 3 depicts a non-limiting example of operations and data movement within a non-limiting example system of driver support for ROMless graphics processors.

FIG. 4 depicts a procedure in an example implementation of driver support for ROMless graphics processors as implemented by a ROMless driver running on a central processing unit (CPU).

FIG. 5 depicts a procedure in an example implementation of driver support for ROMless graphics processors as implemented by a ROMless graphics processor.

### DETAILED DESCRIPTION

### Overview

A system includes a central processing unit (CPU) and a ROMless graphics processor, e.g., a ROMless graphics processing unit (GPU). The graphics processor is “ROMless” in the sense that the graphics processor does not include a non-volatile memory chip dedicated to storing a firmware image of the graphics processor. Notably, the firmware image is a binary file containing data and/or executable instructions for initializing and configuring hardware elements of the graphics processor to ensure functionally correct operation of the graphics processor. In order for the ROMless graphics processor to operate without a non-volatile memory chip that stores the firmware image, therefore, the ROMless graphics processor is configured to obtain the firmware image from the CPU.

To obtain the firmware image from the CPU, an interface is to be established between the CPU and the graphics processor. However, features of the interface, operations performed to establish the interface, and/or sequences of operations to establish the interface vary for different combinations of GPU and CPU architectures. Due to this, conventionally-configured host systems are typically compatible with ROMless graphics processors of only one GPU architecture produced by a same vendor as the CPU.

Accordingly, the techniques described herein relate to a ROMless driver that supports ROMless operation of a plurality of GPU architectures, and integration of the ROMless driver into a plurality of CPU architectures. The ROMless driver, for instance, includes a plurality of firmware images of a plurality of GPU architectures. Each respective firmware image includes the instructions and/or data for configuring and initializing a respective GPU architecture. Each respective firmware image additionally includes multiple assembly logic blocks having assembly code (e.g., instructions and/or data) for establishing an interface between a respective GPU architecture and multiple CPU architectures. Different assembly logic blocks (whether contained in a same firmware image or different firmware images) represent different architecture-specific sequences of operations for establishing architecture-specific interfaces between different combinations of GPU and CPU architectures.

During a secure boot sequence of the ROMless graphics processor, the ROMless driver establishes an interface between the CPU and the ROMless graphics processor using the assembly logic block specific to the architecture of the CPU and contained within the firmware image specific to the GPU architecture of the ROMless graphics processor. Furthermore, the ROMless driver communicates the firmware image that is specific to the GPU architecture of the ROMless graphics processor to the ROMless graphics processor via the established interface. Upon receiving the firmware image, the ROMless graphics processor authenticates and executes the firmware image, thereby ensuring that the ROMless graphics processor is ready to receive and execute graphics processing workloads from an operating system running on the CPU.

By enabling the graphics processor to operate without a dedicated non-volatile memory chip for storing the firmware image, the described techniques reduce the cost of producing the graphics processor and reduce hardware footprint for the system. Moreover, the described techniques offer increased platform flexibility as compared to conventional techniques. Indeed, in contrast to conventional techniques which offer ROMless support for only specific combinations of CPU and graphics processor architectures produced by the same vendor, the described techniques offer ROMless support for a multitude of graphics processor architectures and a multitude of CPU architectures produced by the same or different vendors.

In some aspects, the techniques described herein relate to a system comprising a central processing unit (CPU) having a driver that includes a plurality of firmware images of a plurality of graphics processor architectures, the plurality of firmware images each including a plurality of assembly logic blocks of a plurality of CPU architectures, the CPU configured to establish, by the driver, an interface between a graphics processor and the CPU using an assembly logic block of the CPU within a firmware image of the graphics processor, the graphics processor having removed therefrom a non-volatile memory chip dedicated to storing the firmware image, and communicate, by the driver, the firmware image of the graphics processor via the interface for execution by the graphics processor

In some aspects, the techniques described herein relate to a system, wherein at least one of features of the interface, operations performed to establish the interface, and a sequence of operations to establish the interface are different for different assembly logic blocks of the driver associated with different graphics processor architectures and different CPU architectures.

In some aspects, the techniques described herein relate to a system, wherein each firmware image of the driver includes logic for initializing hardware elements of a different respective graphics processor architecture, thereby enabling integration of the graphics processor into the system as any of the plurality of graphics processor architectures.

In some aspects, the techniques described herein relate to a system, wherein each firmware image of the driver includes the plurality of assembly logic blocks for establishing the interface between a respective graphics processor architecture and the plurality of CPU architectures, thereby enabling implementation of the driver within the plurality of CPU architectures.

In some aspects, the techniques described herein relate to a system, wherein the driver is configured in accordance with a unified extensible firmware interface (UEFI) standard.

In some aspects, the techniques described herein relate to a system, wherein the CPU, during an initial boot sequence for the system, is configured to load the driver from non-volatile memory of the CPU, and authenticate the driver in accordance with the UEFI standard.

In some aspects, the techniques described herein relate to a system, wherein to establish the interface, the CPU is configured to allocate, by the driver, a portion of system memory to the interface, and configure, by the driver, a memory access path enabling the graphics processor to access the portion of the system memory.

In some aspects, the techniques described herein relate to a system, wherein to communicate the firmware image, the CPU is configured to write, by the driver, the firmware image to the portion of the system memory.

In some aspects, the techniques described herein relate to a system, wherein the CPU is further configured to communicate, by the driver and via the interface, a notification to the graphics processor indicating that the firmware image has been written to the portion of the system memory, the notification instructing the graphics processor to read the firmware image from the portion of the system memory and sequentially authenticate and execute a plurality of firmware logic blocks of the firmware image.

In some aspects, the techniques described herein relate to a system, wherein the CPU is further configured to receive, by the driver, a notification via the interface indicating that the firmware image has been executed by the graphics processor, and initialize, by the driver, a display driver for the CPU responsive to the notification, the display driver enabling output of graphical content by a display device of the system during an initial boot sequence of the system.

In some aspects, the techniques described herein relate to a device comprising a graphics processor having removed therefrom a non-volatile memory chip dedicated to storing a firmware image of the graphics processor, the graphics processor configured to receive the firmware image of the graphics processor from a driver that includes a plurality of firmware images of a plurality of graphics processor architectures, the firmware image received via an interface established by the driver using an assembly logic block of a central processing unit (CPU) of the device, the assembly logic block included within the firmware image of the graphics processor, and execute the firmware image.

In some aspects, the techniques described herein relate to a device, wherein the plurality of firmware images of the driver each include a plurality of assembly logic blocks of a plurality of CPU architectures.

In some aspects, the techniques described herein relate to a device, wherein at least one of features of the interface, operations performed to establish the interface, and a sequence of operations to establish the interface are different for different assembly logic blocks of the driver associated with different graphics processor architectures and different CPU architectures.

In some aspects, the techniques described herein relate to a device, wherein each firmware image of the driver includes the plurality of assembly logic blocks for establishing the interface between a respective graphics processor architecture and the plurality of CPU architectures, thereby enabling implementation of the driver within the plurality of CPU architectures.

In some aspects, the techniques described herein relate to a device, wherein each firmware image of the driver includes logic for initializing hardware elements of a different respective graphics processor architecture, thereby enabling integration of the graphics processor into the device as any one of the plurality of graphics processor architectures.

In some aspects, the techniques described herein relate to a device, wherein the interface includes a portion of system memory allocated to the interface and a memory access path enabling the graphics processor to access the portion of the system memory.

In some aspects, the techniques described herein relate to a device, wherein to receive the firmware image, the graphics processor is configured to read the firmware image from the portion of the system memory via the memory access path.

In some aspects, the techniques described herein relate to a device, wherein to execute the firmware image, the graphics processor is configured to sequentially authenticate and execute different firmware logic blocks of the firmware image.

In some aspects, the techniques described herein relate to a device, wherein the graphics processor is configured to communicate a notification to the driver via the interface indicating that the firmware image has been executed, the notification instructing the driver to initialize a display driver for the CPU that enables output of graphical content by a display device of the device during an initial boot sequence of the device.

In some aspects, the techniques described herein relate to a method comprising establishing, by a driver of a central processing unit (CPU) that includes a plurality of firmware images of a plurality of acceleration processor architectures, an interface between an acceleration processor and the CPU using an assembly logic block of the CPU within a firmware image of the acceleration processor, and communicating, by the driver, the firmware image of the acceleration processor via the interface for execution by the acceleration processor, the acceleration processor having removed therefrom a non-volatile memory chip dedicated to storing the firmware image of the acceleration processor.

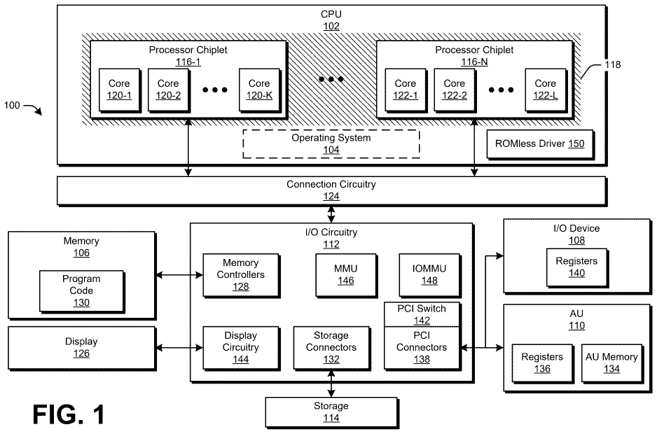

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

In this example, the CPU 102 is depicted as including a ROMless driver 150. For instance, the AU 110 is configured as a ROMless graphics processor having removed therefrom a dedicated read-only memory (ROM) chip for storing a firmware image of the ROMless graphics processor. Given this, the ROMless driver 150 includes a plurality of firmware images of different graphics processor architectures. During an initial boot sequence of the processing system 100, the ROMless driver is configured to communicate, to the ROMless graphics processor, the firmware image that is specific to the architecture of the ROMless graphics processor. As a result, the ROMless driver 150 supports initialization and configuration of the ROMless graphics processor in accordance with the firmware image. Although depicted in the CPU 102, the ROMless driver 150 is included in and/or is implemented by one or more different components of the processing system 100, such as the CPU 102, the memory 106, the I/O device 108, the AU 110, the I/O circuitry 112, the storage 114, and so forth. In at least one implementation, the ROMless driver 150 or portions of the ROMless driver 150 are included in at least two of the depicted components of the processing system 100. By way of example, the ROMless driver 150 may be included in or otherwise implemented by at least the CPU 102 and the system memory 106.

The CPU 102 includes one or more processor chiplets 116, which are communicatively coupled together by a data fabric 118 in one or more implementations. Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. These memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 128 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

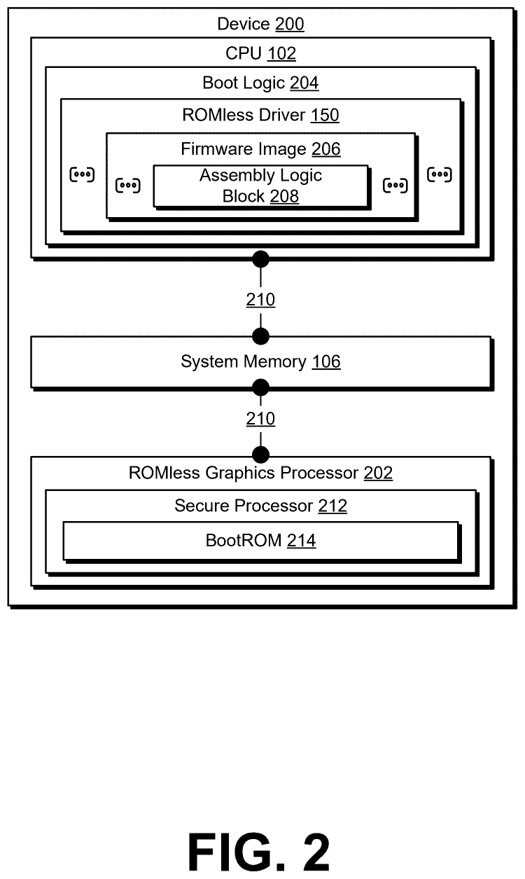

FIG. 2 is a block diagram of a non-limiting example device 200 to implement driver support for ROMless graphics processors. In one or more examples, the device 200 is configured as any one or more of the example devices discussed above with reference to FIG. 1 to implement the processing system 100. The device 200 includes the CPU 102 (e.g., the host processor), which is an electronic circuit configured to run an operating system that manages execution of applications. For instance, the applications correspond to software programs having executable instructions, and the operating system (e.g., the OS 104) schedules the execution of those instructions, e.g., on the CPU 102 or connected processors in a multi-processor system. The techniques described herein support integration of the CPU 102 into the device 200 as any one of a plurality of CPU architectures, including but not limited to including, x86 CPUs, ARM CPUs, and RISC-V CPUs.

Furthermore, the device 200 includes a ROMless graphics processor 202 (e.g., a graphics processing unit (GPU)), which is an electronic circuit configured to perform graphics processing tasks, such as rendering graphics and processing visual data for output, e.g., via the display 126. In scenarios in which the device 200 implements the processing system 100, the ROMless graphics processor 202 is configured as the AU 110 of the processing system 100. Notably, many GPUs are configured as ASICs, and the architecture of GPU ASICs designed for different applications (e.g., gaming, general purpose graphics processing, artificial intelligence and machine learning, cloud computing and data center operations, automotive applications, and virtual reality/augmented reality) are different. The techniques described herein support implementation of the ROMless graphics processor 202 as any one of a plurality of GPU architectures designed for the aforementioned applications and/or other unmentioned applications. Differences in GPU architecture include but are not limited to including, different numbers of cores and/or compute units, different memory types, different data bus widths, and so on.

The graphics processor 202 is “ROMless” in the sense that the graphics processor 202 does not include a non-volatile memory chip dedicated to storing a firmware image of the graphics processor 202. While the graphics processor 202 is characterized herein as “ROMless,” the term “ROMless” encapsulates the absence of a dedicated non-volatile memory chip of any type (e.g., a read-only (ROM) chip, a programmable ROM (PROM) chip, an erasable programmable ROM (EPROM) chip, an electronically erasable programmable (EEPROM) chip, a flash memory chip, and so on) that is dedicated to storing a firmware image of the graphics processor 202. In various ROM-based graphics processor configurations, the firmware image is stored in a serial peripheral interface (SPI) ROM chip. In accordance with the described techniques, however, the SPI ROM chip is removed from the ROMless graphics processor 202.

As further discussed below, the firmware image of the graphics processor 202 is a binary file containing data and firmware code/executable instructions for initializing and configuring hardware elements of the graphics processor 202. Loading and executing the firmware image is essential for ensuring that the graphics processor 202 is initialized and configured properly to enable the CPU 102 to offload graphics processing applications and workloads for execution by the graphics processor 202.

In order for the ROMless graphics processor 202 to operate without a non-volatile memory chip that stores the firmware image, therefore, the graphics processor 202 is configured to obtain the firmware image from the CPU 102 in various scenarios. To do so, the CPU 102 is to establish an interface between the CPU 102 and the ROMless graphics processor 202 that enables the CPU 102 to communicate the firmware image to the graphics processor 202. However, features of the interface, operations that are to be performed to establish the interface, and/or sequences of operations to be performed to establish the interface are different for different combinations of GPU and CPU architectures. Due to this, conventionally-configured CPUs are limited by the types of GPU architectures that are compatible with the CPU. For instance, a conventionally-configured CPU is typically compatible with ROMless graphics processors of only one GPU architecture produced by a same vendor as the CPU.

Accordingly, techniques of driver support for ROMless graphics processors are discussed herein which support a plurality of GPU architectures. In accordance with the described techniques, the CPU 102 includes boot logic 204, as shown. The boot logic 204 represents instructions and/or data (e.g., software or firmware) for initializing external hardware components of the device 200 and/or loading the operating system of the device 200. Examples of the boot logic 204 include, but are not limited to including, a system basic input/output system (SBIOS) or a bootloader program. As a specific but non-limiting example, the boot logic 204 is the SBIOS when the CPU 102 is configured in accordance with the x86 architecture, and the boot logic 204 is the bootloader program when the CPU 102 is configured in accordance with the ARM architecture or the RISC-V architecture. In various implementations, the boot logic 204 is maintained within non-volatile memory (e.g., ROM, PROM, EPROM, EEPROM, and/or flash memory) of the CPU 102.

As shown, the boot logic 204 includes the ROMless driver 150 having a plurality of firmware images 206 (e.g., integrated firmware images (IFWIs)) associated with a plurality of GPU architectures. The firmware image 206 of a GPU architecture, for instance, is a binary file that contains data and firmware code/instructions executable to initialize and operate a graphics processor 202 configured in accordance with the GPU architecture. In various examples, the firmware image 206 of a GPU architecture includes firmware logic blocks, each representing instructions for initializing and configuring different hardware elements of a graphics processor configured in accordance with the GPU architecture. Examples of firmware logic blocks within a firmware image 206 of a GPU architecture include, but are not limited to including, a basic input/output system (BIOS) for the GPU architecture, memory controller firmware for the GPU architecture (e.g., instructions for configuring a memory controller of the graphics processor 202 for memory access), power management firmware for the GPU architecture (e.g., instructions for managing transitions between power states), thermal management firmware (e.g., instructions for monitoring and controlling the temperature of the graphics processor 202 to prevent overheating), and the like.

As shown, each of the firmware images 206 include multiple assembly logic blocks 208. The assembly logic blocks 208 of a firmware image 206 associated with a GPU architecture include assembly code (e.g., executable instructions and/or data) for establishing and/or configuring an interface 210 between multiple CPU architectures and the GPU architecture. Different assembly logic blocks 208 within a firmware image 206 represent different assembly code for establishing the interface 210 between the GPU architecture and different CPU architectures. Moreover, each assembly logic block 208 in the firmware image 206 is preceded by a header including information about the CPU architecture for which the assembly logic block 208 is designed. This enables the ROMless driver 150 to select the appropriate assembly logic block 208 associated with the particular architecture of the CPU 102 and establish the interface 210 by executing the selected assembly logic block 208.

The interface 210 enables the ROMless driver 150 to communicate the corresponding firmware image 206 via the interface 210 to the ROMless graphics processor 202 for execution. Thus, rather than having a dedicated non-volatile memory chip for storing the firmware image 206, the firmware image 206 of the ROMless graphics processor 202 is contained within the ROMless driver 150 and communicated to the ROMless graphics processor 202 during an initial boot sequence for the device 200.

The ROMless driver 150 is responsible for performing the operations for establishing the interface 210 and communicating the firmware image 206 to the ROMless graphics processor 202. In accordance with the described techniques, the ROMless driver 150 is configured in accordance with a firmware interface standard, and the boot logic 204 is also configured in accordance with the firmware interface standard. Thus, to initiate the configuration and initialization process of the ROMless graphics processor 202, the boot logic 204 calls the ROMless driver 150 via a common interface of the firmware interface standard. As part of this, the boot logic 204 loads and authenticates the ROMless driver 150 during the initial boot sequence for the device 200 in accordance with the firmware interface standard. In at least one example, the ROMless driver 150 is integrated within a firmware image of the boot logic 204.

Accordingly, the ROMless driver 150 is compatible and implementable within a plurality of CPU architectures having boot logic 204 configured in accordance with the firmware interface standard without altering an existing codebase of the boot logic 204. In at least one example, the firmware interface standard is a unified extensible interface (UEFI) standard, thereby supporting compatibility with CPU architectures having boot logic 204 configured in accordance with the UEFI standard, e.g., CPUs configured in accordance with the x86 architecture, the ARM architecture, or the RISC-V architecture. Other firmware interfaces are also contemplated, such as BIOS, Coreboot, and Open Firmware.

As shown, the CPU 102 further includes the system memory 106. In accordance with the described techniques, the interface 210 established by the ROMless driver 150 is a memory interface. As part of establishing the interface 210, for instance, the ROMless driver 150 allocates a portion of the system memory 106 to the interface 210. Furthermore, the ROMless driver 150 configures a memory access path which enables the ROMless graphics processor 202 to access the portion of the system memory 106. Given this, the ROMless driver 150 communicates the firmware image 206 to the ROMless graphics processor 202 by copying (e.g., writing) the firmware image 206 to the allocated portion of the system memory 106. Furthermore, the ROMless graphics processor 202 obtains the firmware image 206 by reading the firmware image 206 from the allocated portion of the system memory 106.

It should be noted that different assembly logic blocks 208 contained within different firmware images 206 (of different GPU architectures), as well as different assembly logic blocks 208 contained within a same firmware image 206 (of a same GPU architecture) have different assembly code. Indeed, features of the interface 210, operations to establish the interface 210, and/or the sequence of operations to establish the interface 210 are different for different assembly logic blocks 208. These differences are brought about by different combinations of GPU and CPU architectures employing different access protocols (e.g., direct memory access (DMA) or memory-mapped input/output (MMIO)), different memory allocation mechanisms (e.g., fixed or dynamic), different interconnect technologies (e.g., Peripheral Component Interconnect Express (PCIe) or Infinity Fabric), different numbers of hardware registers of the graphics processor 202 connected to the system memory 106 and different numbers of interconnects therebetween, and/or different data path configurations (having different data bus widths and communication speeds).

As shown, the ROMless graphics processor 202 includes a secure processor 212, which is an electronic circuit configured to execute security-related operations by running bootROM 214, such as secure boot processes and firmware authentication. The secure processor 212, for example, is a multi-purpose autonomous security processor (MPASP). The bootROM 214 is stored in Read-Only Memory (ROM) of the secure processor 212, and in various implementations, is the first set of instructions that executes when the graphics processor 202 is initially powered on. The bootROM 214 includes data and/or executable instructions for initializing and configuring the ROMless graphics processor 202 in two phases. For instance, the bootROM 214, during a first phase, utilizes instructions and/or data stored on the ROM chip of the secure processor 212 to perform basic initialization tasks for the ROMless graphics processor 202. Examples of such basic initialization tasks include, but are not limited to including, fuse distribution, clock initialization, performing Built-In-Self-Test (BIST) process(es) on memory components of the secure processor 212, initializing vector table(s) and base address(es) thereof, initializing stack pointers in memory, and initializing global variables of the ROMless graphics processor 202.

During a second phase, the bootROM 214 reads the firmware image 206 from the allocated portion of system memory 106, and the ROMless graphics processor 202 sequentially authenticates and executes firmware logic blocks of the firmware image 206. Here, authenticating a firmware logic block of the firmware image 206 includes one or more of verifying a digital signature of the firmware logic block using a public key, calculating a hash for the firmware logic block of the firmware image using a hash function and comparing the calculated hash with a known hash value of the firmware logic block, validating a certificate chain of the firmware logic block to ensure the firmware logic block is signed by a trusted authority, enforcing compliance with the secure boot policy of the secure processor 212, and ensuring that the firmware logic block has not been tampered with since it was signed. By executing the firmware image 206, the graphics processor 202 transitions from an initialization state to an operational state. At this point, the graphics processor 202 is ready to receive and execute graphics processing applications and/or workloads from the operating system (e.g., the OS 104) running on the CPU 102.

Accordingly, the techniques described herein support initialization and configuration of the ROMless graphics processor 202 that does not include a dedicated non-volatile memory chip for storing the firmware image 206 of the graphics processor 202. This reduces the cost of producing the ROMless graphics processor 202 and reduces hardware footprint for the system 100 because the system 100 operates without a dedicated SPI ROM chip on the graphics processor 202. Hardware footprint savings enable more compact printed circuit boards (PCBs), which is particularly beneficial for space-constrained devices 200.

Moreover, the described techniques offer increased platform flexibility as compared to conventional techniques. For instance, the ROMless driver 150 includes a firmware image 206 for each one of a plurality of GPU architectures, and each of the firmware images 206 include assembly logic for each one of a plurality of CPU architectures. In other words, the ROMless driver 150 abstracts the architecture-specific complexities of establishing the interface 210 between different CPU architectures and different GPU architectures, alleviating the boot logic 204 from handling these complexities. Thus, in contrast to conventional techniques which offer ROMless support for only specific combinations of CPU and graphics processor architectures produced by a same vendor, the described techniques offer ROMless support for a multitude of CPU and graphics processor architectures produced by multiple vendors.

Although techniques are discussed herein in the context of a ROMless driver that supports system integration of ROMless processors of a plurality of GPU architectures, these examples are not to be construed as limiting. Rather, the described techniques are extendable to support system integration of multiple architectures of any one or more of a variety of types of ROMless acceleration processors, including but not limited to, artificial intelligence processors (e.g., inference processors, tensor processors, artificial intelligence engines (AIEs), neural processing units (NPUs)), digital signal processors (DSPs), field-programmable gate arrays (FGPAs), and cryptographic accelerators. To support this functionality, for example, the ROMless driver 150 additionally or alternatively includes firmware images 206 and assembly logic blocks 208 for a plurality of acceleration processor architectures of one or more different acceleration processor types.

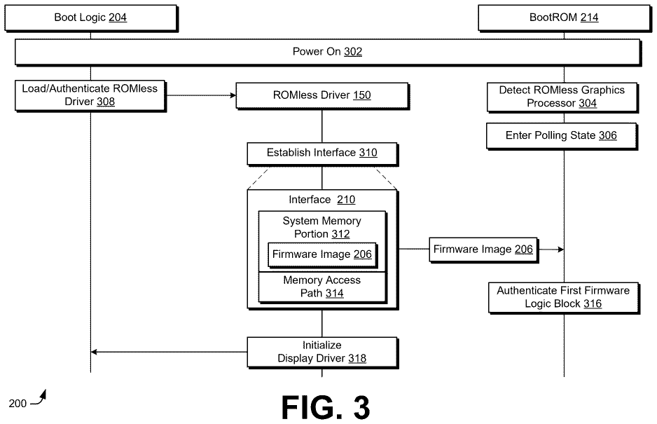

FIG. 3 depicts a non-limiting example 300 of operations and data movement within a non-limiting example system of driver support for ROMless graphics processors. As shown, the example 300 depicts the boot logic 204, the ROMless driver 150, and the bootROM 214 performing operations. Notably, operations performed by the boot logic 204 and the ROMless driver 150 are operations performed by the CPU 102 running and/or executing the boot logic 204 and the ROMless driver 150. Similarly, operations performed by the bootROM 214 are operations performed by the secure processor 212 running and/or executing the bootROM 214.

As shown at 302, the device 200 is powered on (or restarted). As part of an initial boot sequence, power is supplied to the ROMless graphics processor 202. As previously mentioned, the bootROM 214 is a first set of instructions that executes when the graphics processor 202 is powered up in one or more implementations. Here, the bootROM 214 performs the aforementioned basic initialization tasks, and determines that the graphics processor 202 is ROMless, e.g., detect ROMless graphics processor 304. More specifically, the bootROM 214 detects that the ROMless graphics processor 202 does not include a non-volatile memory chip dedicated to storing the firmware image 206 of the graphics processor 202. For example, the bootROM 214 detects an absence of an SPI ROM device within the GPU architecture of the graphics processor 202. In response to this detection, the bootROM 214 enters a polling state 306, waiting to take further action until receiving a notification that the interface 210 has been established and the firmware image 206 is ready to be read from the allocated system memory 106.

Meanwhile, the boot logic 204 loads and authenticates the ROMless driver 150 as part of the initial boot sequence for the device 200, as shown at 308. As previously mentioned, the boot logic 204 is configured in accordance with a firmware interface standard, and as such, loading and authenticating the ROMless driver 150 follows protocols and methods specified by the firmware interface standard. When configured in accordance with the UEFI standard, for instance, loading and authenticating the ROMless driver 150 follows protocols and methods specified by the UEFI technical specification. As noted above, a preconfigured UEFI interface enables the boot logic 204 to call the ROMless driver 150 without modifying the existing codebase of the boot logic 204. Notably, the ROMless driver 150 is stored in non-volatile memory of the CPU 102, and as such, the ROMless driver 150 is loaded from the non-volatile memory of the CPU 102.

Once authenticated, the ROMless driver 150 establishes the interface 210, as shown at 310. To do so, the ROMless driver 150 allocates a system memory portion 312 of the system memory 106 to the interface 210. Furthermore, the ROMless driver 150 executes the assembly logic block 208 specific to the architecture of the CPU 102 contained within the firmware image 206 specific to the GPU architecture of the ROMless graphics processor 202. By doing so, the ROMless driver 150 establishes a memory access path 314 (e.g., memory buses and/or interconnects) between the system memory portion 312 and the ROMless graphics processor 202. As part of executing the assembly logic block 208 to establish the interface 210, the ROMless driver 150 initializes hardware registers of the graphics processor 202. In various examples, the initialized hardware registers configure memory controller(s) of the ROMless graphics processor 202, specify base memory addresses of the system memory portion 312 allocated to the interface 210, specify memory access protocols such as direct memory access (DMA), and/or specify communication protocols such as PCIe, and the like. Notably, the ROMless driver 150 follows architecture-specific sequences of operations to establish an architecture-specific interface 210 by executing the assembly logic block 208 specific to the GPU and CPU architecture combination implemented by the system.

Using the interface 210, the ROMless driver 150 communicates the firmware image 206 that is specific to the GPU architecture of the ROMless graphics processor 202 to the ROMless graphics processor 202. To do so, the ROMless driver 150 copies (e.g., writes) the firmware image 206 to the system memory portion 312, as illustrated.

In response to writing the firmware image 206 to the system memory portion 312, the ROMless driver 150 communicates a notification to the bootROM 214 indicating that the interface 210 has been established, and the firmware image 206 is present in the system memory portion 312. The notification is communicated via the interface 210. For example, the ROMless driver 150 writes the notification to the system memory portion 312, and the bootROM 214 reads the notification from the system memory portion 312 via the memory access path 314. In response to receiving the notification, the bootROM 214 wakes from the polling state 306, and reads the firmware image 206 from the system memory portion 312 via the memory access path 314.

As shown at 316, the bootROM 214 authenticates a first firmware logic block of the firmware image 206. The firmware image 206 specifies that the firmware logic blocks are to be executed in a particular order, and as such, the ROMless graphics processor 202 sequentially authenticates and executes the firmware logic blocks in the particular order. By way of example, the bootROM 214 authenticates the first firmware logic block in the particular order, and in response to a successful authentication, the ROMless graphics processor 202 executes the first firmware logic block. The first firmware logic block includes instructions for authenticating the second firmware logic block in the particular order, and as such, execution of the first firmware logic block includes authentication processes performed with respect to the second firmware logic block. In response to a successful authentication of the second firmware logic block, the ROMless graphics processor 202 executes the second firmware logic block in the particular order, and so on. This process is repeated for each firmware logic block of the firmware image 206, in which each subsequent firmware logic block in the particular order is authenticated by the ROMless graphics processor 202 executing the previous firmware logic block in the particular order.

Once the firmware image 206 has been executed, the last firmware logic block of the firmware image 206 communicates a notification to the ROMless driver 150 indicating that the firmware image 206 has been executed. The notification is communicated via the interface 210. For example, the last firmware logic block in the firmware image 206 writes the notification to the system memory portion 312 via the memory access path 314, and the ROMless driver 150 reads the notification from the system memory portion 312. In response to receiving the notification, the ROMless driver 150 initializes a display driver for the boot logic 204, as shown at 318.

The display driver, for instance, represents data and/or executable instructions (e.g., software or firmware) for enabling output of graphical content by a display device of the device 200 during an initial boot sequence of the device 200. By way of example, the OS 104 running on the CPU 102 offloads graphics processing workloads and applications to the ROMless graphics processor 202 using a separate, graphics driver. However, at this stage of the boot sequence, the OS 104 has not been loaded in various implementations. Accordingly, the display driver provides a display service for the device 200 during the initial boot sequence before the OS 104 has been fully loaded. Once the operating system is loaded, the display driver is replaced with the graphics driver which offers more advanced graphics output capabilities. In at least one example, the display driver is a graphics output protocol (GOP) driver.

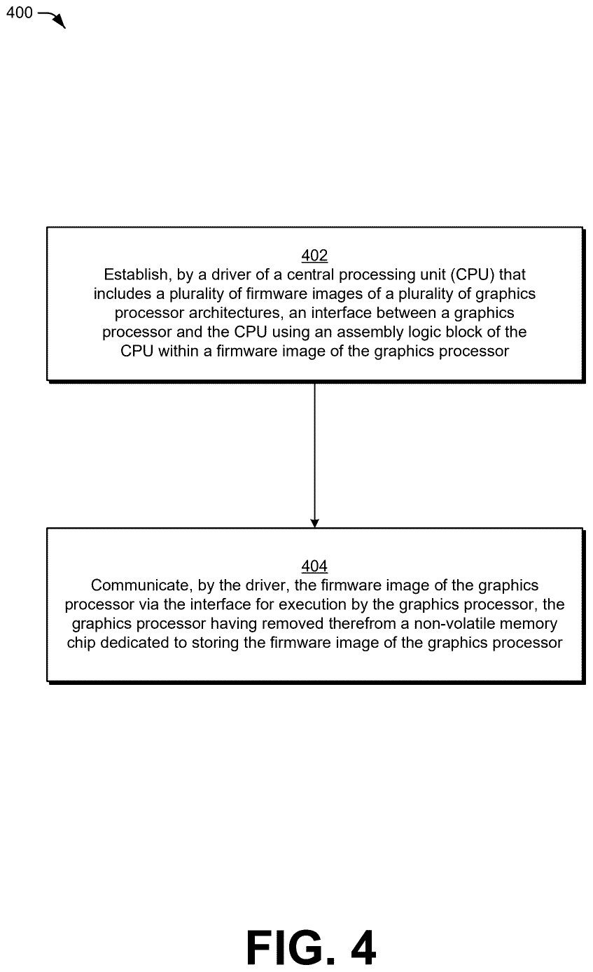

FIG. 4 depicts a procedure 400 in an example implementation of driver support for ROMless graphics processors as implemented by a ROMless driver running on a CPU. In the procedure 400, an interface is established between a graphics processor and a CPU by a driver of the CPU that includes a plurality of firmware images of a plurality of graphics processor architectures, wherein the interface is established using an assembly logic block of the CPU within a firmware image of the graphics processor (block 402). By way of example, the ROMless driver 150 includes a plurality of firmware images 206 of a plurality of GPU architectures. A firmware image 206 of a respective GPU architecture includes multiple assembly logic blocks 208 defining architecture-specific sequences of operations for establishing architecture-specific interfaces 210 between the multiple CPU architectures and the respective GPU architecture. Using the assembly logic block 208 specific to the architecture of the CPU 102 contained within a firmware image 206 specific to the GPU architecture of the ROMless graphics processor 202, the ROMless driver 150 establishes the interface 210.

The driver communicates the firmware image of the graphics processor via the interface for execution by the graphics processor, wherein the graphics processor has removed therefrom a non-volatile memory chip dedicated to storing the firmware image of the graphics processor (block 404). By way of example, the ROMless graphics processor 202 is “ROMless” in the sense that the graphics processor 202 does not include a non-volatile memory chip (e.g., an SPI ROM chip) dedicated to storing the firmware image 206 of the graphics processor 202. Thus, to enable proper configuration and initialization of the ROMless graphics processor 202, the graphics processor 202 is to obtain the firmware image 206 from the CPU 102. As part of this, the ROMless driver 150 communicates the firmware image 206 to the ROMless graphics processor 202 via the established interface 210. Furthermore, the ROMless graphics processor 202 initializes and configures hardware elements of the ROMless graphics processor 202 by authenticating and executing the firmware image 206.

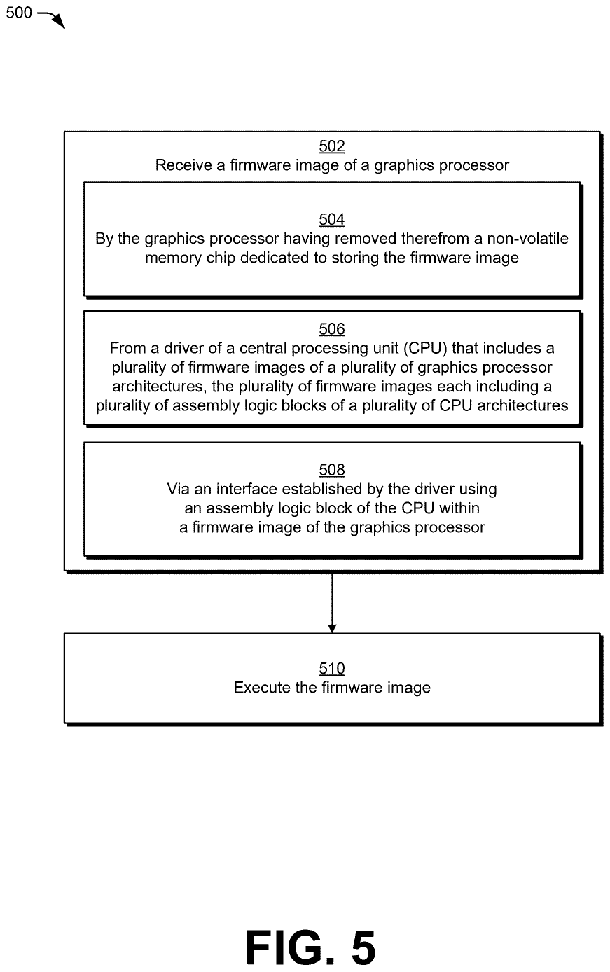

FIG. 5 depicts a procedure 500 in an example implementation of driver support for ROMless graphics processors as implemented by a ROMless graphics processor. In the procedure 500, a firmware image of a graphics processor is received (block 502). In particular, the firmware image is received by the graphics processor which has removed therefrom a non-volatile memory chip dedicated to storing the firmware image (block 504). For example, the ROMless graphics processor 202 does not include a non-volatile memory chip (e.g., an SPI ROM chip) dedicated to storing the firmware image 206 of the graphics processor 202. Thus, to enable proper configuration and initialization of the ROMless graphics processor 202, the ROMless graphics processor 202 is configured to receive the firmware image 206 from the CPU 102.

More specifically, the firmware image is received from a driver of a CPU that includes a plurality of firmware images of a plurality of graphics processor architectures, wherein the plurality of firmware images each include a plurality of assembly logic blocks of a plurality of CPU architectures (block 506). By way of example, the ROMless driver 150 includes a plurality of firmware images 206 of a plurality of GPU architectures. A firmware image 206 of a respective GPU architecture includes multiple assembly logic blocks 208 defining architecture-specific sequences of operations for establishing architecture-specific interfaces 210 between the multiple CPU architectures and the respective GPU architecture.

Particularly, the firmware image is received via an interface established by the driver using an assembly logic block of the CPU within a firmware image of the graphics processor (block 508). By way of example, the ROMless driver 150 establishes the interface 210 between the ROMless driver 150 and the ROMless graphics processor 202 using the assembly logic block 208 specific to the architecture of the CPU 102 contained within a firmware image 206 specific to the GPU architecture of the ROMless graphics processor 202. Furthermore, the ROMless driver 150 communicates the firmware image 206 to the ROMless graphics processor 202 using the established interface 210.

Furthermore, the firmware image is executed (block 510). In response to receiving the firmware image 206 via the interface 210, for instance, the ROMless graphics processor 202 sequentially authenticates and executes firmware logic blocks of the firmware image 206.

What is claimed is:

1. A system comprising:
a central processing unit (CPU) having a driver that includes a plurality of firmware images of a plurality of graphics processor architectures, the plurality of firmware images each including a plurality of assembly logic blocks of a plurality of CPU architectures, the CPU configured to:
establish, by the driver, an interface between a graphics processor and the CPU using an assembly logic block of the CPU within a firmware image of the graphics processor, the graphics processor having removed therefrom a non-volatile memory chip dedicated to storing the firmware image; and
communicate, by the driver, the firmware image of the graphics processor via the interface for execution by the graphics processor.

2. The system of claim 1, wherein at least one of features of the interface, operations performed to establish the interface, and a sequence of operations to establish the interface are different for different assembly logic blocks of the driver associated with different graphics processor architectures and different CPU architectures.

3. The system of claim 1, wherein each firmware image of the driver includes logic for initializing hardware elements of a different respective graphics processor architecture, thereby enabling integration of the graphics processor into the system as any of the plurality of graphics processor architectures.

4. The system of claim 1, wherein each firmware image of the driver includes the plurality of assembly logic blocks for establishing the interface between a respective graphics processor architecture and the plurality of CPU architectures, thereby enabling implementation of the driver within the plurality of CPU architectures.

5. The system of claim 1, wherein the driver is configured in accordance with a unified extensible firmware interface (UEFI) standard.

6. The system of claim 5, wherein the CPU, during an initial boot sequence for the system, is configured to load the driver from non-volatile memory of the CPU, and authenticate the driver in accordance with the UEFI standard.

7. The system of claim 1, wherein to establish the interface, the CPU is configured to:
allocate, by the driver, a portion of system memory to the interface; and
configure, by the driver, a memory access path enabling the graphics processor to access the portion of the system memory.

8. The system of claim 7, wherein to communicate the firmware image, the CPU is configured to write, by the driver, the firmware image to the portion of the system memory.

9. The system of claim 8, wherein the CPU is further configured to communicate, by the driver and via the interface, a notification to the graphics processor indicating that the firmware image has been written to the portion of the system memory, the notification instructing the graphics processor to read the firmware image from the portion of the system memory and sequentially authenticate and execute a plurality of firmware logic blocks of the firmware image.

10. The system of claim 1, wherein the CPU is further configured to:
receive, by the driver, a notification via the interface indicating that the firmware image has been executed by the graphics processor; and
initialize, by the driver, a display driver for the CPU responsive to the notification, the display driver enabling output of graphical content by a display device of the system during an initial boot sequence of the system.

11. A device comprising:
a graphics processor having removed therefrom a non-volatile memory chip dedicated to storing a firmware image of the graphics processor, the graphics processor configured to:
receive the firmware image of the graphics processor from a driver that includes a plurality of firmware images of a plurality of graphics processor architectures, the firmware image received via an interface established by the driver using an assembly logic block of a central processing unit (CPU) of the device, the assembly logic block included within the firmware image: and
execute the firmware image.

12. The device of claim 11, wherein the plurality of firmware images of the driver each include a plurality of assembly logic blocks of a plurality of CPU architectures.

13. The device of claim 12, wherein at least one of features of the interface, operations performed to establish the interface, and a sequence of operations to establish the interface are different for different assembly logic blocks of the driver associated with different graphics processor architectures and different CPU architectures.

14. The device of claim 12, wherein each firmware image of the driver includes the plurality of assembly logic blocks for establishing the interface between a respective graphics processor architecture and the plurality of CPU architectures, thereby enabling implementation of the driver within the plurality of CPU architectures.

15. The device of claim 11, wherein each firmware image of the driver includes logic for initializing hardware elements of a different respective graphics processor architecture, thereby enabling integration of the graphics processor into the device as any one of the plurality of graphics processor architectures.

16. The device of claim 11, wherein the interface includes a portion of system memory allocated to the interface and a memory access path enabling the graphics processor to access the portion of the system memory.

17. The device of claim 16, wherein to receive the firmware image, the graphics processor is configured to read the firmware image from the portion of the system memory via the memory access path.

18. The device of claim 11, wherein to execute the firmware image, the graphics processor is configured to sequentially authenticate and execute different firmware logic blocks of the firmware image.

19. The device of claim 11, wherein the graphics processor is configured to communicate a notification to the driver via the interface indicating that the firmware image has been executed, the notification instructing the driver to initialize a display driver for the CPU that enables output of graphical content by a display device of the device during an initial boot sequence of the device.

20. A method comprising:
establishing, by a driver of a central processing unit (CPU) that includes a plurality of firmware images of a plurality of acceleration processor architectures, an interface between an acceleration processor and the CPU using an assembly logic block of the CPU within a firmware image of the acceleration processor; and
communicating, by the driver, the firmware image of the acceleration processor via the interface for execution by the acceleration processor, the acceleration processor having removed therefrom a non-volatile memory chip dedicated to storing the firmware image of the acceleration processor.
